(19) United States
(12) Patent Application Publication
(10) Pub. No.: US 2002/0068527 A1
(43) Pub. Date: Jun. 6, 2002

(54) SYSTEMS AND METHODS FOR COMMUNICATING MESSAGES TO DISADVANTAGED MOBILE USER TERMINALS

(76) Inventors: LARRY WILLIAM MASSINGILL, SELMA, NC (US); TORBJORN WILSON SOLVE, CARY, NC (US); RICHARD E. WEISS, CARY, NC (US); YI-PIN ERIC WANG, RALEIGH, NC (US); KUMAR BALACHANDRAN, CARY, NC (US)

Correspondence Address: MYERS BIGEL SIBLEY & SAJOVEC, PO BOX 37428, RALEIGH, NC, 27627, US

(21) Appl. No.: 09/264,766

(22) Filed: Mar. 9, 1999

(51) Int. Cl. H04B 7/185; H04B 7/00; H04Q 7/20

(52) U.S. Cl. 455/13.4; 455/12.1; 455/522

(57) ABSTRACT

Satellite communications systems include a base station configured to communicate messages to disadvantaged mobile radiotelephone terminals. A mobile radiotelephone terminal receives a communication from a base station via a first high power paging channel and, if disadvantaged, monitors a second high power forward-only radiotelephone channel identified in the communication. The base station, upon determining that the mobile radiotelephone is disadvantaged, broadcasts the pending message to the mobile radiotelephone terminal via the second forward-only radiotelephone channel.

### FIELD OF THE INVENTION

The present invention relates generally to communications and, more particularly, to radiotelephone satellite communications.

### BACKGROUND OF THE INVENTION

In time division multiple access (TDMA) cellular telephone systems, such as the terrestrial Global System for Mobile Communications (GSM), communications between a mobile user terminal and a base station may require the establishment of a duplex channel. Conventionally, messages such as pages (i.e., an indication to a specific mobile user terminal of a call or information) and broadcast information (i.e., information sent to all mobile user terminals within range of a base station) are transmitted unacknowledged on unidirectional (i.e., forward only) common control channels that can be monitored by all mobile user terminals. If a message, other than a page, is to be directed to a specific mobile user terminal, an additional dedicated channel is conventionally allocated to establish bi-directional communications between the mobile user terminal and base station. This dedicated channel may be used to communicate messages or other information to and from the mobile user terminal. During establishment of this dedicated channel, an encryption key may be generated based upon information transmitted between the mobile user terminal and base station that is unique for this particular connection. This key can be used to encrypt speech and data transmitted over the air, securing the information from interception by others.

In satellite cellular systems, such as those adhering to the Asia Cellular Satellite (ACeS) system Satellite Air Interface Specification (SAIS), a two-tiered signaling system exists from a base station to a mobile user terminal. In this type of system, a bi-directional signaling path is used (similar to terrestrial cellular) when a mobile user terminal is able to receive high rate, normal power signals from a base station and the base station is able to receive high rate, normal power signals from the mobile user terminal.

When this is not the case, a base station conventionally has the ability to send a low data rate signal at higher effective power to a mobile user terminal. This is known as a high margin signal. Power boost is accomplished by both increasing transmitted power and by applying additional coding which permits a mobile user terminal to properly decode the lower data rate signal at a lower received signal strength. The mobile user terminal, being transmit power restricted, conventionally does not return signals in this mode. Accordingly, only unidirectional signaling is supported via these dedicated channels.

In terrestrial cellular systems, received signal strengths are conventionally assumed to be high enough, when a mobile user terminal is within range of a base station, that a bi-directional channel can be requested and established for all transfer of information. In satellite communications systems, signal strength may be very low at a mobile user terminal. For example, blockage by buildings and trees may render a mobile user terminal “disadvantaged”. Accordingly, it is conventionally desired to provide some way of transmitting information to a mobile user terminal that is disadvantaged.

In an ACeS SAIS satellite cellular communications system, a mobile user terminal is signaled by a base station on a paging channel, which conventionally has a message size of about 53 bits. Paging channels are a limited resource and are sized to meet the peak demand for call originations within a coverage area for a control channel (i.e., a beam). These paging channels are typically the only channels that may carry mobile specific (i.e., targeted) messages without hand-over to a dedicated, bi-directional channel. Unfortunately, it is desirable to be able to transmit lengthy messages to specific mobile user terminals, even when the mobile user terminals are disadvantaged, without requiring user interaction to move the mobile user terminal into an advantaged position (i.e., unblocked by buildings, trees, and the like).

Because a paging channel is shared among all the users in a beam, it is generally undesirable to sacrifice the bandwidth of the paging channel to provide a channel to transmit data to a disadvantaged mobile user terminal. Accordingly, when a mobile user terminal in a satellite communications system is disadvantaged, a high rate bi-directional channel generally cannot be established to transfer a message, as is the case in GSM systems. Furthermore, when a bi-directional communication channel cannot be established, the exchange of encryption information may be difficult. Accordingly, the security of information transmitted to a mobile user terminal on a unidirectional channel may be compromised.

In addition, when messages are transmitted to a disadvantaged mobile user terminal, use of a paging channel to transmit both paging messages, which are on the order of 40 to 60 bits of data, and text messages of several hundred bits, may require the paging channel to be oversized. Use of a paging channel to transmit both paging and text messages may result in an allocation of excess spectrum because message traffic is assumed to be infrequent. Use of a paging channel to transmit both paging and text messages may also increase the delay encountered in sending pages to mobile user terminals. This delay may occur because pages may not be sent on a paging channel for the duration of the message being sent, which could be several seconds.

### SUMMARY OF THE INVENTION

In view of the above, it is an object of the present invention to facilitate communications between a base station and disadvantaged mobile user terminals without requiring mobile user terminal repositioning in order to establish bi-directional communications.

It is another object of the present invention to increase the number of “forward-only” communications channels without impacting capacity or function of existing broadcast and paging channels.

It is another object of the present invention to improve the probability of successful reception by a disadvantaged mobile user terminal of a message transmitted from a base station.

It is another object of the present invention to facilitate protecting the security of information transmitted from a base station to a mobile user terminal via a unidirectional channel.

It is another object of the present invention to provide a simple low data rate acknowledgement of a successfully received message to a base station from a disadvantaged user when possible.

These and other objects of the present invention are provided by a satellite communications system including a base station configured to identify the existence of a pending message to a disadvantaged mobile radiotelephone terminal on a first high power forward-only radiotelephone channel, and then communicate the message to the disadvantaged mobile radiotelephone terminal on a second high power forward-only radiotelephone channel. A mobile radiotelephone terminal monitoring the first forward-only radiotelephone channel establishes a bi-directional link with the base station upon receipt of an indication of a pending message from the base station, if advantaged. If disadvantaged, the mobile radiotelephone terminal begins monitoring a second high power forward-only radiotelephone channel identified in the communication from the base station via the first forward-only radiotelephone channel.

The base station makes a determination that the mobile radiotelephone is disadvantaged if it does not receive a request from the mobile radiotelephone terminal to establish a bi-directional link with the base station or if the establishment of a bi-directional link between the base station and the mobile radiotelephone terminal fails. Upon determining that the mobile radiotelephone terminal is disadvantaged, the base station is configured to broadcast the pending message to the mobile radiotelephone terminal on the second forward-only radiotelephone channel.

The base station is preferably configured to broadcast the pending message in encoded bursts on a repetitive basis, either for a selected number of times or until an acknowledgement is received from the mobile radiotelephone terminal. The bursts may be encrypted using an encryption key used to encrypt data previously transmitted to the mobile radiotelephone terminal.

The mobile radiotelephone is configured to acknowledge receipt of the message to the base station. Furthermore, the mobile radiotelephone may be configured to decrypt the message using a decryption key used to decrypt data previously received from the base station.

According to another aspect of the present invention, a method is provided for communicating messages from a base station to remote, disadvantaged user terminals. The method includes broadcasting from the base station to a user terminal, via a first high power forward-only radiotelephone channel, such as a paging channel, a respective terminal identifier along with an indication of a pending message. The indication of a pending message includes an identifier for the user terminal and at least one additional unused bit.

Responsive to determining that the user terminal is disadvantaged, a message is broadcast from the base station to the user terminal on a second high power forward-only radiotelephone channel, preferably in encrypted bursts. An interval between bursts may be set to obtain a selected data rate and a selected number of channels on a selected frequency and time slot. The bursts may be individually encrypted using an encryption key used to encrypt data previously transmitted to the user terminal. Each message includes the terminal identifier for the user terminal.

According to the present invention, the message may be broadcast from the base station to the user terminal repetitively until receipt of the message is acknowledged by the user terminal or for a predetermined number of times. If the message is broadcast repetitively for a predetermined number of times, the number of times is selected to obtain a desired probability of success of the user terminal receiving the message.

According to another aspect of the present invention, a method of receiving a message from a base station at a remote, disadvantaged user terminal, includes monitoring a first forward-only radiotelephone channel for a communication from the base station indicating a pending message. In response to receiving a communication of a pending message from the base station, the user terminal determines from information contained within the communication an identity of a second forward-only radiotelephone channel over which the pending message will be transmitted from the base station along with frequency and time slot information for the second forward-only radiotelephone channel. The user terminal then monitors the second forward-only radiotelephone channel and receives the message from the base station via the second forward-only radiotelephone channel.

According to another aspect of the present invention, the user terminal may acknowledge the receipt of the message to the base station. Acknowledgement is preferably sent by a high margin acknowledgment message as described in co-assigned Patent Cooperation Treaty (PCT) application WO 97/37507, the disclosure of which is incorporated herein by reference in its entirety. Alternatively, acknowledgment may be sent by normal power channels when the user terminal is no longer disadvantaged.

The present invention utilizes a paging channel as a means for informing a mobile user terminal or groups of terminals that a message is about to be transmitted. The present invention further utilizes an additional channel of equivalent power and data capacity as a paging channel, which a mobile user terminal can monitor to transmit the message. The paging message contains only the channel to be monitored for which the specific frequency and timing has been provided in broadcast information available to the terminal on the common control channel. Information about the channel will fit in a normal paging message, thus only requiring the capacity of a single terminal page to address the message to a single mobile user terminal.

The present invention is advantageous because the number of “forward-only” channels from a base station to a mobile user terminal can be increased without impacting the capacity or function of existing “forward-only” broadcast and paging channels. Furthermore, the present invention allows targeted messages to be transmitted to a disadvantaged mobile user terminal without requiring that the disadvantaged mobile user terminal be repositioned so that a bi-directional link with a base station is established. In fact, according to the present invention, a disadvantaged mobile user terminal is not required to be able to send any information to a base station. Furthermore, the present invention permits the encryption of messages to a disadvantaged mobile user terminal and permits the disadvantaged mobile user terminal to be able to decrypt encrypted messages without having to establish a bi-directional communication channel with a satellite.

According to the present invention, power savings can be achieved at a mobile user terminal because continuous monitoring of a separate message channel in addition to the monitoring of a normal paging channel is not required. The probability of successful reception of a message transmitted to a disadvantaged mobile user terminal is increased because of repetitive transmissions of the message according to the present invention.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram of a radiotelephone satellite communications system according to the present invention.

FIG. 2 is a flowchart illustrating operations of a radiotelephone satellite communications system according to the present invention.

FIG. 3 illustrates a logical channel configuration according to the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is described herein using flowcharts illustrating operations of the present invention. It will be understood that each block of the flowchart illustrations, and combinations of blocks in the flowchart illustrations, can be implemented by computer program instructions. These program instructions may be provided to a processor(s) within a satellite communications system and/or mobile user terminal, such that the instructions which execute on the processor(s) create means for implementing the functions specified in the flowchart block or blocks. The computer program instructions may be executed by the processor(s) to cause a series of operational steps to be performed by the processor(s) to produce a computer implemented process such that the instructions which execute on the processor(s) provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based systems which perform the specified functions or steps, or combinations of special purpose hardware and computer instructions.

### Satellite Communications Systems

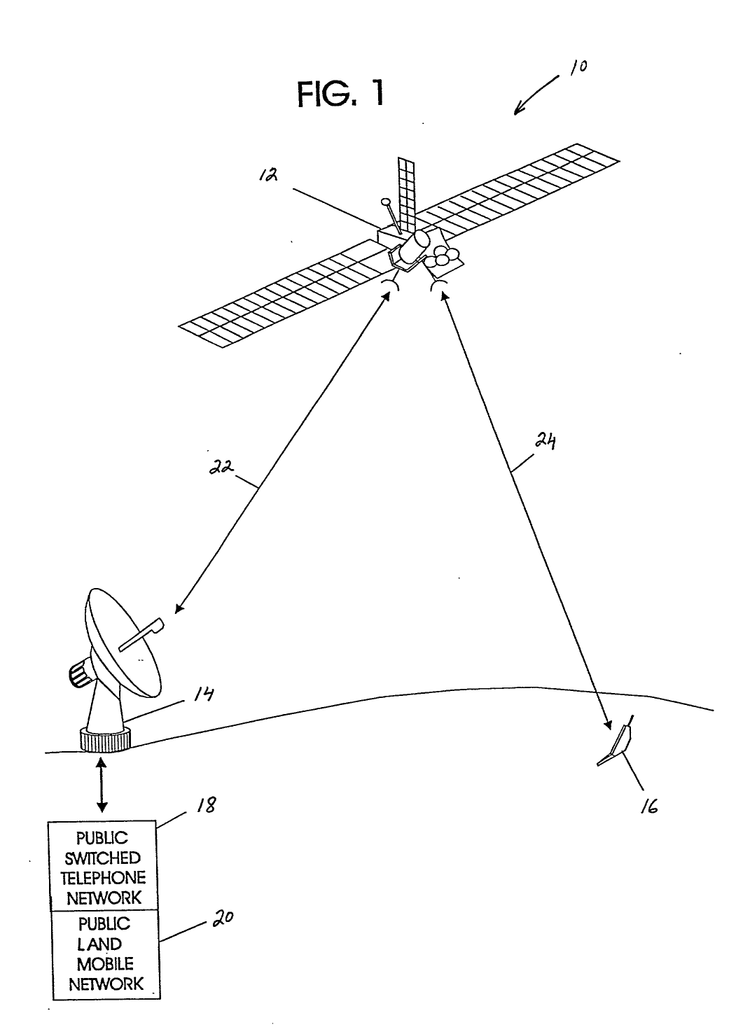

FIG. 1 illustrates a radiotelephone satellite communications system 10 including at least one satellite 12, at least one terrestrial controller or base station 14, and at least one mobile user terminal 16, such as a radiotelephone, portable computer, personal digital assistant, or any other electronic device adapted for radiotelephone communications. The base station 14 may be coupled to a wireless communications system such as a Public Land Mobile Network (PLMN) 20, and/or to a wired communications system such as a Public Switched Telephone Network (PSTN) 18. The base station 14 and satellite 12 are coupled through radio links 22. The satellite 12 and a mobile user terminal 16 are coupled through radio links 24.

Radiotelephone satellite communications systems can provide communications to and from a plurality of mobile user terminals. A satellite can provide service through a plurality of spot beams (or cells) each covering a different geographic region. Moreover, radiotelephone satellite communications systems can include a plurality of satellites and/or a plurality of controllers. Radiotelephone satellite communications systems can facilitate communications between mobile user terminals, or between mobile user terminals and telephones coupled to a public switched telephone network.

Radiotelephone satellite communications systems establish a radiotelephone communications link with a mobile user terminal using a traffic channel via a radio link. For example, a link may be established responsive to a call placed by a telephone from a PSTN or from another mobile user terminal coupled to a satellite in the communications system. The link is established by transmitting a call set up communication (also referred to as a “page”) from a transceiver of a satellite wherein the call set up communication is transmitted at a first power level.

The call set up communication may be transmitted over a control channel. Upon reception of the call set up communication, a mobile user terminal acknowledges receipt thereof and a two-way radiotelephone communications link is established over a dedicated channel, such as a traffic channel. If a mobile user terminal does not receive the call set up communication, or is unable to acknowledge receipt of the call set up communication, the radiotelephone communications link may not be established.

### Forward-Only Signaling Channels

In satellite-based cellular communications systems, several “forward-only” communications channels are generally provided. These channels allow information to be transmitted from a base station to a mobile user terminal, but do not provide a return path to the base station for information from the mobile user terminal. These “forward-only” communications channels may exist in various formats, and are designed to transmit both high data rate, normal power and low data rate high power signals to both advantaged and to disadvantaged mobile user terminals which may otherwise be unable to receive a signal from a base station.

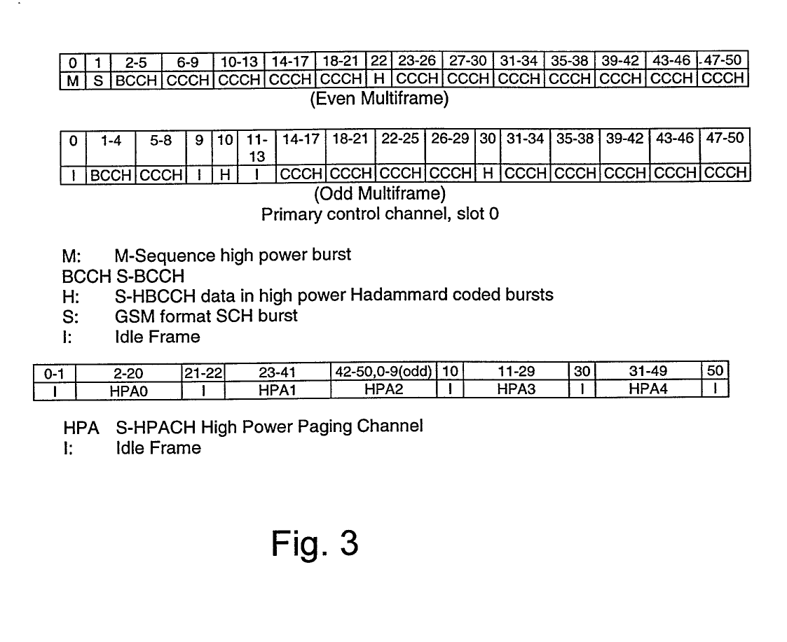

As can be seen in FIG. 3, exemplary forward-only channels which may be used in accordance with the present invention include, but are not limited to, the Satellite High Margin Broadcast Control Channel (S-HBCCH), the Satellite High Margin Paging Channel (S-HPACH), and the Satellite Broadcast Control Channel (S-BCCH). S-HBCCH and S-BCCH channels provide a mobile user terminal with static or slowly changing information about a beam within which the mobile user terminal is located. Part of this information may be required by the mobile user terminal for the mobile user terminal to know which paging channel to monitor for paging messages. This information, combined with the identity of the mobile user terminal (IMSI) is used to select which paging channels within a satellite beam will be used to page a specific mobile user terminal.

An S-HPACH channel transmits short messages consisting of the IMSI of a mobile user terminal whenever a base station is trying to establish a bi-directional link with the mobile user terminal, such as when a mobile user terminal has a call directed to it. Because both the S-HBCCH and S-HPACH channels transmit with boosted signal strength over normal channels, messages transmitted therethrough may be received by a mobile user terminal, even when the mobile user terminal is in a disadvantaged position.

Normally, upon receiving a message (i.e., a page) with its own IMSI embedded therein, a mobile user terminal will attempt to transmit a response to the transmitting base station in order to establish a bi-directional link with the base station. This bi-directional link would then be used to establish a call, send a message to the mobile user terminal, or for any other communication function that the base station and mobile user terminal may require. However, the purpose of the page directed to the mobile user terminal is unknown to the mobile user terminal until a bi-directional link is established.

The present invention may be utilized with any satellite communications system in which high power, forward-only signaling channels are used to reach disadvantaged mobile user terminals.

### Transmitting and Receiving Unacknowledged Messages

According to the present invention, additional information indicating the purpose of a page directed to a mobile user terminal 16 may be included with the IMSI of the mobile user terminal 16 by using spare or new bits. For example, these bits can be used to indicate to a mobile user terminal 16 that the reason for the page is that a message is waiting to be transmitted to the mobile user terminal 16. According to the present invention, a single bit may be used within a page to convey this additional information.

Upon receiving a page, a mobile user terminal 16 may respond, according to the present invention, in one of two ways. If the mobile user terminal perceives, via the strength of the received page signal, that a bi-directional link with the base station 14 can be successfully established (i.e., the mobile user terminal perceives itself as advantaged), the mobile user terminal 16 may proceed as though a normal page was received. The base station 14 may wait for a response from the mobile user terminal and, if a response is received, attempt to establish a bi-directional channel with the mobile user terminal 16 and transmit the message to the mobile user terminal 16 via this channel. The message would be sent to the mobile user terminal 16 in a manner similar to the Short Message Service in conventional communications systems. Alternatively, if the mobile user terminal 16 is disadvantaged and does not attempt to establish a bi-directional channel, or if the establishment of a bi-directional channel fails, the mobile user terminal 16 then attempts to receive an unacknowledged message via a separate channel as described below.

A base station transmits, via S-HBCCH and S-BCCH channels, static information indicating to a mobile user terminal which channel or channels will be used for transmission of unacknowledged user terminal-specific messages. If multiple channels are indicated, a mobile user terminal will use its IMSI number in a modulo operation to identify which channel to monitor. Channel identification, according to the present invention, may be similar to how a mobile user terminal identifies which of several paging channels to monitor for pages targeted thereto.

A base station will then provide one or more new channels (i.e., frequency and time slot) of a structure similar to an S-HPACH channel. This channel will transmit to a mobile user terminal high margin bursts in groups or blocks that can be individually decoded by the mobile user terminal. Preferably, a message will be spread over several blocks. The interval between bursts may be set to obtain any desired data rate and number of channels on a given frequency and time slot, in inverse proportion to each other. Examples of this include, two channels using every other occurrence of a slot, four channels using every fourth occurrence of a slot, and the like.

When a base station has a message to be transmitted to a specific mobile user terminal, the base station transmits a page, or other communication, to the mobile user terminal via a high power paging channel with a flag bit set to indicate that the reason for the page is that there is a pending message. Preferably, a message transmitted to a mobile user terminal via a designated message channel, such as S-HPACH, according to the present invention, consists of 50 bits of an IMSI and 3 unused or spare bits, nominally set to 0.

A mobile user terminal will monitor its own assigned paging channel. If the mobile user terminal receives a page, and if the mobile user terminal is advantaged, the mobile user terminal will attempt to establish a bi-directional channel with the base station. If a bi-directional channel is successfully established, a normal message exchange will occur via the bi-directional channel. Accordingly, the new message channel is not needed and will not be used. However, if the mobile user terminal is disadvantaged, or if the establishment of a bi-directional channel fails, the new message channel will be monitored according to the present invention.

The mobile user terminal uses the information from the broadcast control channel to identify which message channel to monitor. If the base station does not receive a request from the mobile user terminal to establish a bi-directional channel, or if the establishment of a bi-directional channel is unsuccessful, the base station begins to transmit the message on the message channel. The mobile user terminal then begins monitoring and decoding information from the identified message channel. Because there may be messages transmitted on the message channel that are targeted to many mobile user terminals, the base station will precede each message with the IMSI of the intended recipient mobile user terminal in the first transmitted block along with the length (in blocks) of the message. If encryption is enabled, the base station re-uses the last encryption key used to encrypt data to the targeted mobile user terminal to encode data within the message blocks.

A mobile user terminal looks for its own IMSI to appear in a block on the message channel to indicate the start of a message targeted for the mobile user terminal. If the operation has enabled encryption, the mobile user terminal will re-use the last encryption key established between itself and the base station to decode data within the received message blocks transmitted via the message channel.

A mobile user terminal, upon receiving a block on the message channel that contains the mobile user terminal's IMSI, will extract from that block the number of subsequently transmitted blocks that will contain the message. The mobile user terminal will receive and save all successfully decoded blocks of the message up to the number specified in the first block. If the mobile user terminal decodes each of the blocks successfully over one or more occurrences of the message, the message is successfully received.

A base station may repeat a message to a mobile user terminal as many times as may be deemed appropriate to achieve a reasonable probability of success in conveying an entire message to a disadvantaged mobile user terminal. The number of repeat transmissions is a configuration parameter that can be relayed via the broadcast channel. If a mobile user terminal fails to receive all blocks of a message on the first transmission, the mobile user terminal continues to monitor the message channel for subsequent transmissions of the message. The mobile user terminal will then piece together the entire message from all successfully received blocks from the various transmissions. Preferably, broadcast information from the base station will indicate to the mobile user terminal how many times the message will be repeated. Accordingly, the probability that an entire message will be received by a disadvantaged mobile user terminal may be increased.

Once a message has been successfully received by a mobile user terminal, acknowledgement of the successful reception may be made to the transmitting base station via a high margin acknowledgement if such signaling is supported by both the user terminal and base station, or at a future time when the mobile user terminal becomes advantaged. A base station may repeat the above process periodically until the receipt of a message is acknowledged. Alternatively, a base station may transmit a message a fixed number of times and then discard the message at some future point in time.

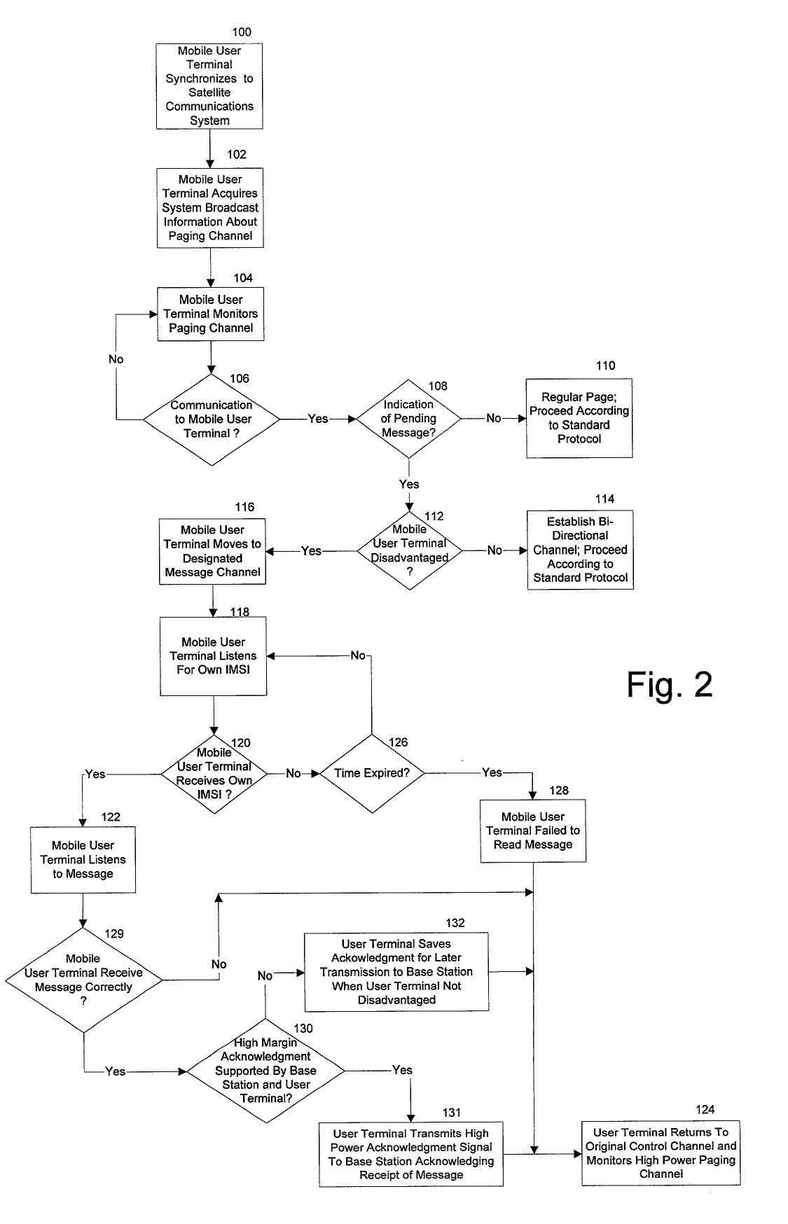

Referring now to FIG. 2, operations for carrying out the present invention are schematically illustrated. A mobile user terminal synchronizes itself to a satellite communications system (Block 100). Synchronization to a satellite communications system by a mobile user terminal is well known to those skilled in this art and need not be described further. A mobile user terminal acquires system broadcast information from a base station regarding which high powered paging channels are to be used as message channels for transmitting unacknowledged, terminal-specific messages (Block 102). A mobile user terminal then monitors the specified paging channel for communications (Block 104). If a communication is received by a mobile user terminal via the specified high powered paging channel (Block 106), the mobile user terminal makes a determination whether the message contains an indication of a pending message (Block 108). If a communication is not received by a mobile user terminal via the specified high powered paging channel, the mobile user terminal continues to monitor the high powered paging channel (Block 104).

If a received message does not contain an indication of a pending message (Block 108), the mobile user terminal receiving the communication recognizes that the communication is a regular page, and proceeds according to standard protocol (Block 110). However, if the communication does contain an indication of a pending message (Block 108), the mobile user terminal makes a determination whether it is disadvantaged (Block 112). If the mobile user terminal is not disadvantaged (hence it is advantaged), the mobile user terminal establishes a bi-directional link or channel with the base station and proceeds to communicate with the base station according to standard protocol (Block 114).

However, if the mobile user terminal determines that it is disadvantaged (Block 112), the mobile user terminal moves to the designated message channel (Block 116) and begins monitoring the message channel for messages containing the mobile user terminal's identifier (IMSI) (Block 118). If the mobile user terminal receives a message containing the mobile user terminal's IMSI via the designated message channel (Block 120), the mobile user terminal listens to the message (Block 122). If a message has been successfully received (Block 129), the mobile user terminal then checks to see if high margin acknowledgement is supported (Block 130). If so, it will send an acknowledgement to the base station (Block 131) and return to monitoring for pages (Block 124). If high margin acknowledgment is not supported, it will set a flag to send an acknowledgement when it becomes advantaged (Block 132) and return to monitoring for pages (Block 124). If the message is not successfully received, it will simply return to monitoring for pages (Block 124).

If the mobile user terminal does not receive a message containing the mobile user terminal's IMSI via the designated message channel (Block 120), a determination is made whether time has expired for monitoring the designated message channel (Block 126). If time has expired, the mobile user terminal has failed to receive the message. Accordingly, the mobile user terminal returns to the original control channel and monitors the high powered paging channel (Block 128 and Block 124). If time has not expired for receiving the message (Block 126), the mobile user terminal continues to monitor the designated message channel for messages containing its own IMSI (Block 118).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of communicating radiotelephone messages from a base station to a remote, disadvantaged user terminal having an identifier associated therewith, the method comprising the steps of:
broadcasting from the base station to the user terminal the associated terminal identifier along with an indication of a pending message on a first high power radiotelephone channel;
determining if the user terminal is disadvantaged; and
responsive to determining that the user terminal is disadvantaged, broadcasting a message from the base station to the user terminal on a second high power radiotelephone channel.

2. A method according to claim 1 wherein the first high power radiotelephone channel is a paging channel.

3. A method according to claim 1 wherein the indication of a pending message comprises the terminal identifier and at least one additional unused bit.

4. A method according to claim 3 wherein the indication of a pending message comprises fifty bits of the terminal identifier and at least one unused bit nominally set to zero.

5. A method according to claim 1 wherein the step of determining if the user terminal is disadvantaged comprises determining whether the user terminal has established a bi-directional low power link with the base station in response to broadcasting the associated user terminal identifier and indication of a pending message to the user terminal.

6. A method according to claim 1 wherein the message is broadcast to the user terminal in bursts.

7. A method according to claim 6 wherein an interval between bursts is set to obtain a selected data rate and a selected number of channels on a selected frequency and time slot.

8. A method according to claim 6 wherein the bursts are individually encrypted.

9. A method according to claim 8 wherein the bursts are individually encrypted using an encryption key used to encrypt data previously transmitted to the user terminal.

10. A method according to claim 6 wherein each burst includes the terminal identifier for the user terminal.

11. A method according to claim 1 wherein the message is broadcast from the base station to the user terminal repetitively.

12. A method according to claim 11 wherein the message is broadcast from the base station to the user terminal repetitively until receipt of the message is acknowledged by the user terminal.

13. A method according to claim 11 wherein the message is broadcast from the base station to the user terminal repetitively for a predetermined number of times.

14. A method according to claim 13 wherein the predetermined number of times is selected to obtain a desired probability of success of the user terminal receiving the message.

15. A method according to claim 1 further comprising the step of transmitting a high margin acknowledgement signal from the user terminal to the base station.

16. A method according to claim 15 wherein the base station is configured to receive and decode the high margin acknowledgement signal.

17. A method of receiving a radiotelephone message from a base station at a remote, disadvantaged user terminal, the method comprising the steps of:
monitoring a first forward-only channel for a communication from the base station indicating a pending message;
responsive to receiving the communication, determining from information contained within the communication an identity of a second forward-only channel over which the pending message will be transmitted from the base station;
monitoring the second forward-only channel; and
receiving the message from the base station via the second forward-only channel.

18. A method according to claim 17 further comprising the step of acknowledging receipt of the message to the base station.

19. A method according to claim 17 further comprising the step of decrypting the received message.

20. A method according to claim 17 wherein the first forward-only channel is a high power paging channel.

21. A method according to claim 17 wherein the communication from the base station comprises a terminal identifier associated with the user terminal.

22. A method according to claim 17 wherein the communication from the base station comprises frequency and time slot information for the second forward-only channel over which the message will be transmitted from the base station.

23. A base station for communicating radiotelephone messages to a remote, disadvantaged user terminal having an identifier associated therewith, the base station comprising:
means for broadcasting to the user terminal on a first high power radiotelephone forward-only channel the associated terminal identifier along with an indication of a pending message;
means for determining if the user terminal is disadvantaged; and
means for broadcasting the pending message to the user terminal on a second high power radiotelephone forward-only channel upon determining that the user terminal is disadvantaged.

24. A base station according to claim 23 wherein the indication of a pending message comprises the terminal identifier and at least one additional unused bit.

25. A base station according to claim 24 wherein the indication of a pending message comprises fifty bits of the terminal identifier and at least one unused bit nominally set to zero.

26. A base station according to claim 23 wherein the means for determining if the user terminal is disadvantaged comprises means for determining whether the user terminal has established a low power bi-directional link with the base station in response to broadcasting the associated user terminal identifier and indication of a pending message to the user terminal.

27. A base station according to claim 23 further comprising means for broadcasting the pending message to the user terminal in bursts.

28. A base station according to claim 27 further comprising means for encrypting the bursts.

29. A base station according to claim 28 further comprising means for encrypting the bursts using an encryption key used to encrypt data previously transmitted to the user terminal.

30. A base station according to claim 23 further comprising means for broadcasting the pending message to the user terminal repetitively.

31. A base station according to 30 further comprising means for broadcasting the pending message to the user terminal repetitively until receipt thereof is acknowledged by the user terminal.

32. A base station according to claim 30 wherein the means for broadcasting the pending message comprises means for broadcasting the pending message to the user terminal repetitively for a predetermined number of times.

33. A mobile radiotelephone terminal, comprising:
means for monitoring a first radiotelephone forward-only channel for a communication from a base station indicating a pending message;
means for determining from information included within a received communication an identity of a second radiotelephone forward-only channel over which the pending message will be transmitted from the base station;
means for monitoring the second radiotelephone forward-only channel; and
means for receiving the pending message from the base station via the second radiotelephone forward-only channel.

34. A mobile radiotelephone terminal according to claim 33 further comprising means for acknowledging to the base station receipt of the pending message.

35. A mobile radiotelephone terminal according to claim 33 further comprising means for decrypting the message.

36. A radiotelephone satellite communications system, comprising:
a base station for communicating radiotelephone messages to remote, disadvantaged mobile radiotelephone terminals, each mobile radiotelephone terminal having a respective identifier associated therewith, the base station comprising:
means for broadcasting to a respective mobile radiotelephone terminal, via a first high power forward-only radiotelephone channel, an associated terminal identifier along with an indication of a pending message;
means for determining if the mobile radiotelephone terminal is disadvantaged; and
means for broadcasting the pending message to the mobile radiotelephone terminal on a second high power forward-only radiotelephone channel upon determining that the mobile radiotelephone terminal is disadvantaged; and
wherein each mobile radiotelephone terminal comprises:
means for monitoring the first high power forward-only radiotelephone channel for a communication from the base station indicating a pending message;
means for determining from information contained within a received communication an identity of a second high power forward-only radiotelephone channel over which a pending message will be transmitted from the base station;
means for monitoring the second high power forward-only radiotelephone channel; and
means for receiving the pending message from the base station via the second high power forward-only radiotelephone channel.

37. A satellite communications system according to claim 36 wherein the means for determining if the mobile radiotelephone terminal is disadvantaged comprises means for determining whether the mobile radiotelephone terminal has established a low power bi-directional link with the base station in response to broadcasting the associated user terminal identifier and indication of a pending message to the mobile radiotelephone terminal.

38. A satellite communications system according to claim 36 wherein the base station further comprises means for broadcasting the message to a mobile radiotelephone terminal in bursts.

39. A satellite communications system according to claim 38 wherein the base station further comprises means for encrypting the bursts.

40. A satellite communications system according to claim 39 wherein the base station further comprises means for encrypting the bursts using an encryption key used to encrypt data previously transmitted to a respective mobile radiotelephone terminal.

41. A satellite communications system according to claim 36 wherein the base station further comprises means for broadcasting the pending message to the mobile radiotelephone terminal repetitively.

42. A satellite communications system according to 41 wherein the base station further comprises means for broadcasting the pending message to the mobile radiotelephone terminal repetitively until receipt thereof is acknowledged by the mobile radiotelephone terminal.

43. A satellite communications system according to claim 41 wherein the base station comprises means for broadcasting the pending message to the mobile radiotelephone terminal repetitively for a predetermined number of times.

44. A satellite communications system according to claim 36 wherein each mobile radiotelephone terminal further comprises means for acknowledging receipt to the base station of a message.

45. A satellite communications system according to claim 36 wherein each mobile radiotelephone terminal further comprises means for decrypting a received message.
